(19) United States
(12) Patent Application Publication
(10) Pub. No.: US 2009/0325751 A1
(43) Pub. Date: Dec. 31, 2009

(54) Drive Chain Cover

(76) Inventor: Uwe Carstensen, Hamburg (DE)

Correspondence Address: Smartpat PLC, 1785 BRADFORD RD., BIRMINGHAM, MI, 48009, US

(21) Appl. No.: 12/466,362

(22) Filed: May 14, 2009

(30) Foreign Application Priority Data
Jun. 27, 2008 (DE) 102008031803.5

(51) Int. Cl. B62J 13/00; F16G 13/02; B23P 11/00

(52) U.S. Cl. 474/145; 29/434

(57) ABSTRACT

A protective cover for a drive chain made of multiple pivotally connected drive chain links, e.g. a bicycle drive chain, is provided. The protective cover essentially encloses the drive chain and revolves with the drive chain around two or more sprockets. The protective cover is an elastic corrugated tube.

Further, a method for protecting a drive chain is provided comprising the step of enclosing the drive chain within a longitudinally slit corrugated tube.

### CLAIM FOR PRIORITY

This application claims priority to German patent application number DE 10 2008 031 803.5, which was filed in the German language on Jun. 27, 2008 and which is hereby incorporated by reference.

### TECHNICAL FIELD

The present invention generally relates to a protective cover for a drive chain, and more particularly, to a protective cover for a drive chain of a bicycle comprising a corrugated tube that revolves with the drive chain.

### BACKGROUND OF THE INVENTION

Bicycles are typically powered by a continuous drive chain, which revolves between a front sprocket that is connected to pedals and a rear sprocket, which is connected to the bicycle's rear wheel. Various attempts have been made to protect a bicyclist's leg or clothing from touching the drive chain, since the drive chain is typically lubricated with oil or grease, and may spoil garment surrounding the bicyclist's leg when touched. A common protective measure is to provide a mechanical chain guard that is placed between the drive chain and the bicyclist's leg. Such chain guards are typically attached to the bicycle's frame and not in contact with the drive chain.

In an alternative approach U.S. Pat. No. 4,854,924 discloses a cover device for a drive chain stretched between a front sprocket and a rear sprocket of a bicycle. A large number of chain link cover elements are provided, one for each chain link. Each chain link cover element is U-shaped and snaps onto one chain link. The cover elements are open on their inside, thus allowing the front and rear sprocket to engage the drive chain. The individual chain link cover elements are in contact with each other, thus providing an essentially continuous outer wall in the straight area of the drive chain between the sprockets. The outer wall, however, is interrupted where the chain wraps around the sprockets. Small segments, whose size depends on the sprocket's diameter, open between the chain link elements. This allows lubricants to escape and dirt to enter the cover in the sprocket area, diminishing the effectiveness of the cover. U.S. Pat. No. 4,854,924 is hereby incorporated by reference thereto in its entirety.

CH 179633 discloses a chain cover for vehicles, specifically bicycles, consisting of a continuous rubber tube that encloses the drive chain. The rubber tube has an opening slit on its inside to allow the front and rear sprockets to engage the drive chain. The rubber tube revolves with the drive chain when the bicycle is operated. However, such rubber tubes wear quickly as they revolve with the drive chain and exhibit insufficient durability.

In an unrelated field corrugated tubes and corrugated pipes have been used as protective covers for electrical wiring harnesses and as transport conduits for liquids and gases. Exemplary corrugated tubes are disclosed in U.S. Pat. No. 7,045,709 and U.S. Pat. No. 5,673,468, both of which are hereby incorporated by reference in their entireties. Corrugated tubes may be made of thermoplastic resins and may comprise a longitudinal slit. Pre-slit corrugated tubes have been used in vehicles to protect wires and hoses from being damaged. Corrugated tubes are typically flexible, so that they can be easily bent longitudinally. At the same time they are radially stable, i.e. they essentially maintain their cross-sectional shape.

Therefore, in light of the problems associated with existing approaches, there is a need for improved drive chain covers, e.g. for bicycles, that can be easily attached to the drive chain, and which reliably and durably protect the drive chain.

### SUMMARY OF THE INVENTION

In one aspect of the present invention a protective cover for a drive chain is provided, which comprises a corrugated tube essentially enclosing the drive chain and revolving with the drive chain around two or more sprockets.

The corrugated tube is very flexible when bent perpendicular to its longitudinal axis. Due to this flexibility the corrugated tube minimally affects the chain's friction as it revolves with the chain, thus providing an effective chain cover while maintaining a high level of comfort. The corrugated tube has a high longitudinal flexural fatigue strength and high inherent radial rigidity. The corrugated tube typically contacts the chain only along small sections of its inner wall, thereby providing a significantly improved durability compared to chain covers made of rubber, which contact the chain along large portions of their inner wall.

In another aspect the protective cover is formed as an endless loop, consistent with the endless loop drive chain. The protective cover comprises longitudinally spaced openings along its inner circumference. Sprocket teeth can reach through these openings to engage the drive chain. The drive chain path and revolution of the drive chain around two or more sprockets is essentially unaffected by the presence of the protective cover.

In a preferred embodiment the longitudinally spaced openings in the protective cover are formed as a slit that is provided in longitudinal direction along the length of the protective cover. This allows the protective cover to move relative to the drive chain, without interfering with the sprocket teeth's ability to engage the drive chain. In this embodiment the protective cover does not need to be aligned with the drive chain.

In another aspect the width of the longitudinal slit in the corrugated tube forming the protective cover may be smaller than the width of the drive chain. The corrugated tube may be slightly radially expanded, causing a clamp fit with the chain links of the protected drive chain. The clamp fit securely attaches the corrugated tube to the drive chain, preventing accidental separation of the corrugated tube from the drive chain. Due to the high dimensional stability of the corrugated tube's diameter the clamp fit is maintained over a long service life.

In a further aspect an endless protective drive chain cover is formed by connecting the two ends of a corrugated tube enclosing the drive chain, thus forming an endless loop. The two ends of the corrugated tube may be permanently connected. The two ends may also be connected by a connection element, allowing the two ends to be separated when needed. The connection between the two ends of the corrugated tube is preferably sealed, so that drive chain lubricants cannot escape the protective cover. The two ends of the corrugated tube may be welded together, glued together, or they may be snapped together using a form fit connection.

Corrugated tubes for use as protective drive chain covers may be made of polyamide (PA), polyethylene (PE), polyurethane (PU), polypropylene (PP), or polytetrafluorethylene (PP). Corrugated tubes made of those materials are abrasion resistant, and chemically resistant, especially against oil.

Corrugated tubes and corrugated pipes are commercially available, e.g. to protect electrical wires in machines such as robots or automobiles. Such existing corrugated tubes may be used as protective covers for a drive chain, if the corrugated tube is longitudinally slit and appropriately sized. For use as a drive chain cover a pre-slit corrugated tube may be cut to correspond in length with the drive chain. The corrugated tube may then be placed over the drive chain by expanding the corrugated tube's longitudinal slit. Finally, the two ends of the corrugated tube may be connected to form an endless loop.

The corrugated tube or corrugated pipe is characterized by high flexibility along the drive chain's travel path. The corrugated tube can durably and with low abrasion revolve with the drive chain around the curved sprockets, in case of a bicycle around the front sprocket that is operatively connected to the pedals and the rear sprocket that is operatively connected to the rear wheel. Its corrugation structure causes the corrugated tube to be dimensionally stable in regards to its cross section, i.e. in its radial extension, causing a desirable clamp fit effect to the protected drive chain.

The corrugated tube is longitudinally flexible and may be longitudinally compressed, to compensate for lengthening of the drive chain, which may be an effect of wear on the drive chain. Longitudinal flexibility aids in connecting the two ends of the corrugated tube when forming an endless loop.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is an illustrative side view of an exemplary drive chain with a protective cover, wherein parts of the protective cover are omitted for illustrative purposes.

FIG. 2 is a cross section through an exemplary corrugated tube chain cover, in the area of a corrugation valley and with a sprocket tooth engaging the drive chain.

### DETAILED DESCRIPTION

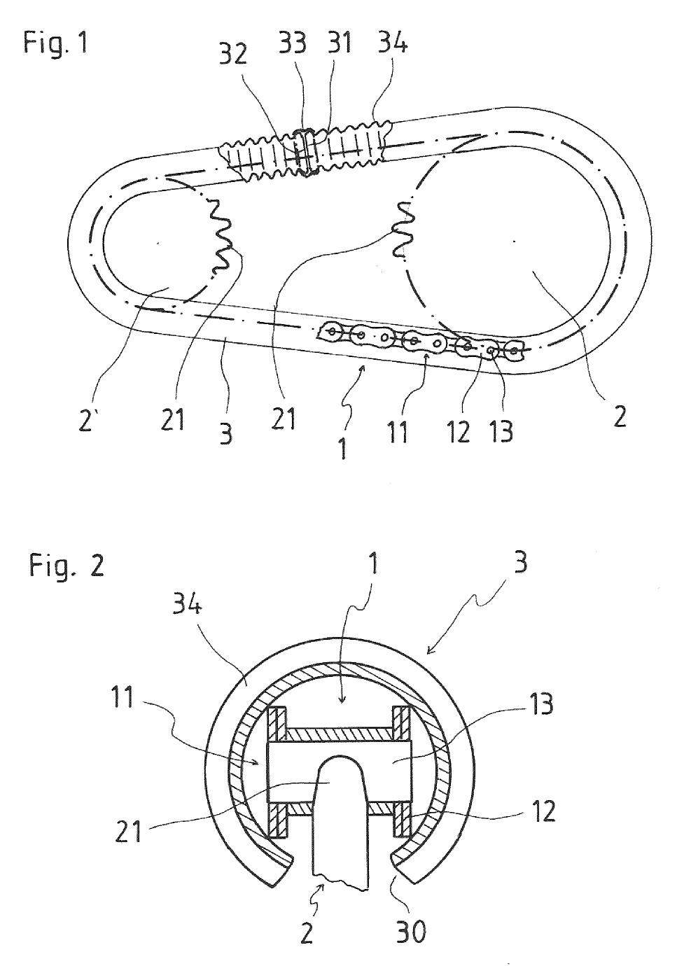

Referring to FIG. 1, a side view of an exemplary drive chain 1 with protective cover 3 is illustrated. Drive chain 1 is wrapped around two sprockets 2 and 2′. Protective cover 3 essentially encloses drive chain 1. Drive chain 1 is a commonly known roller chain, formed of many pivotally connected chain link elements 11 as an endless chain. For illustrative purposes, only a few chain link elements 11 inside protective cover 3 are shown. The drive chain path is indicated by a dot-dash line. Drive chain 1 is wrapped around sprockets 2 and 2′ having teeth 21 which are engaging drive chain 1. Drive chain 1 transfers torque from a first sprocket 2 to a second sprocket 2′. Sprockets 2 and 2′ are illustrated by a dot-dash line showing the path of drive chain 1 as it wraps around sprockets 2 and 2′. For illustration purposes, sprocket teeth 21, which are located around the entire perimeter of sprockets 2 and 2′, are shown only in a small sector of sprocket 2 and 2′. The illustrated drive train arrangement is commonly used in bicycles.

A protective cover 3, which is made of corrugated tube 34, encloses drive chain 1. Corrugated tube 34 has a length corresponding to the length of drive chain 1 so that both ends 31 and 32 of corrugated tube 34 are right next to each other. Thereby, corrugated tube 34 forms an endless loop. Corrugated tube 34 has a wave-shaped outer wall. The profile of this outer wall may be a sine curve, an involute, a triangle, a rectangle, a square or any other shape causing the outer wall of corrugated tube 34 to alternate between corrugation peaks and corrugation valleys. The corrugated profile causes corrugated tube 34 to have high inherent radial rigidity.

FIG. 2 illustrates a cross sectional view through protective cover 3 and drive chain 1 in the area of sprocket 2. Corrugated tube 34 comprises a longitudinal slit 30. Slit 30 is located along the inner side of drive chain 1, i.e. along the side of drive chain 1 that faces sprockets 2. Sprocket teeth 21 engage drive chain link 11 through slit 30 of corrugated tube 3.

Drive chain link 11, being a part of drive chain 1, comprises link plates 12, which in known roller chains are alternating inner and outer link plates, and which are connected by link pin 13. Corrugated tube 34 encloses drive chain 1 such, that its inner wall has only punctual contact with link plates 12 of chain link 11. While corrugated tube 34 is illustrated having a circular cross section it should be appreciated that many different profiles can be used. Corrugated tube 34 may, for example, have a rectangular cross section, elliptical cross section, or otherwise rounded cross section. Preferably corrugated tube 34 is highly flexible, has high longitudinal flexural fatigue strength, and high inherent radial rigidity.

Referring back to FIG. 1, a connection of two ends 31 and 32 of corrugated tube 34 is illustrated schematically. Corrugated tube 34 is cut in length such that, when it is mounted onto drive chain 1, both ends 31 and 32 are adjacent to each other, forming an endless tube. The two ends 31 and 32 of corrugated tube 34 may be connected by a connection clip 33 that uses a form fit design to snap onto both ends 31 and 32, thereby securely connecting both ends. Connection clip 33 may engage a corrugation valley next to each end 31 and 32 of corrugated tube 34. This prevents connection clip 33 from sliding along corrugated tube 34. The two ends 31 and 32 of corrugated tube 34 may be separable, e.g. by removing connection clip 33. This allows removing corrugated tube 34 from drive chain 1, e.g. for service or to replace drive chain 1 independent of corrugated tube 34. The two ends 31 and 32 of corrugated tube 34 may also be permanently connected, e.g. by gluing both ends 31 and 32 of corrugated tube 34 together.

Corrugated tube 34 may be mounted onto drive chain 1 as follows: First, corrugated tube 34 is cut to a length that is longer than that of drive chain 1. The extra length of corrugated tube 34 causes it to become longitudinally compressed during or after assembly to drive chain 1. This generates the necessary pressure in case of a pressure fit connection. Also, the extra length of corrugated tube 34 compensates for wear induced lengthening of drive chain 1 during service, thereby maintaining the corrugated tube's protective qualities throughout its life.

Next, slit 30 of corrugated tube 34 is expanded, preferably by using a tool to overcome the high clamp force acting against a radial expansion of corrugated tube 3. Corrugated tube 34 is then pushed over drive chain 1 in the area of the expanded slit 30, so that corrugated tube 34 assumes its intended position and encloses drive chain 1. This process may be used to retrofit existing bicycle drive chains with a protective cover, without a need to remove the drive chain or either one of the bicycle's sprockets.

Alternatively, corrugated tube 34 may be mounted to drive chain 1 before drive chain 1 is mounted to the bicycle. In this method corrugated tube 34 may be longitudinally compressed while drive chain 1 is mounted onto the bicycle, i.e. before two ends of drive chain 1 are linked together into an endless chain. To facilitate this assembly process corrugated tube 34 is selected such that it can be longitudinally compressed to allow access to the two ends of drive chain 1, so that the drive chain can be linked into an endless chain while it is already enclosed within corrugated tube 34.

After corrugated tube 34 has been mounted to drive chain 1 both ends 31 and 32 of corrugated tube 34 will be adjacent to each other and can be connected by snapping a connection clip 33 over both ends 31 and 32 of corrugated tube 34. Ends 31 and 32 may also snap directly into each other using a form fit design. Alternatively, or in addition thereto, both ends 31 and 32 may be glued or welded together or pushed together by the expansion force of a longitudinally compressed corrugated tube 34.

Protective cover 3 according to one aspect of the invention is smooth-running and quiet. Drive chain 1 inside protective cover 3 is largely protected from atmospheric exposure, corrosion and dirt. Also, lubrication of drive chain 1 is largely preserved by the protective cover 3.

When used on bicycles the protective drive chain cover 3 can make mechanical chain guards or chain cases between the front and rear sprockets obsolete. The protective cover 3 effectively prevents contact between the bicyclist and lubricants used on the drive chain 1. Especially when used on folding bikes the protective chain cover 3 also protects the user during folding and carrying of the bike. Use of a chain guard ring mounted to the front sprocket 2 may be advisable in combination with the protective drive chain cover 3 to prevent the bicyclist's garment from getting caught between drive chain 1 and front sprocket 2.

Protective cover 3 according to an aspect of the present invention can be used on a large variety of bicycles, e.g. internal gear hub style bicycles and derailleur style bicycles. It can be used with drive chains of various widths, and with sprockets of various diameters. Protective cover 3 may be reused, when drive chain 1 is replaced.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A protective cover for a drive chain, comprising a corrugated tube essentially enclosing the drive chain and revolving with the drive chain around two or more sprockets.

2. A protective cover as in claim 1, wherein the corrugated tube comprises longitudinally spaced openings along its inner circumference through which teeth of the two or more sprockets engage the drive chain.

3. A protective cover as in claim 2, wherein the longitudinally spaced openings is a slit provided in longitudinal direction along the length of the corrugated tube.

4. A protective cover as in claim 3, wherein the width of the slit is less than the width of the drive chain.

5. A protective cover as in claim 1, wherein the two ends of the corrugated tube are permanently or detachably connected, thereby forming an endless tube.

6. A protective cover as in claim 5, wherein the two ends of the corrugated tube are
a) welded together, or
b) glued together, or
c) form-fitted snapped together,
or connected by a combination of the above.

7. A protective cover as in claim 1, wherein the corrugated tube is made of material selected from the group consisting of polyamide (PA), polyethylene (PE), polyurethane (PU), polypropylene (PP) and polytetrafluoroethylene (PTFE) or a combination thereof.

8. A method for protecting a drive chain comprising the step of enclosing the drive chain within a longitudinally slit corrugated tube.

9. The method as in claim 8, further comprising the steps of
cutting the corrugated tube,
expanding the corrugated tube's longitudinal slit,
placing the corrugated tube over the drive chain, and
connecting both ends of the corrugated tube.

10. The method as in claim 8, further comprising the step of connecting both ends of the corrugated tube, thereby creating an endless chain cover.

11. A drive chain enclosed within a corrugated tube.

12. A drive chain as in claim 11, wherein small segments of the inner wall of the corrugated tube are in contact with link plates forming part of the drive chain.

13. A drive chain as in claim 11, wherein the corrugated tube travels with the drive chain around two of more sprockets.

14. A drive chain as in claim 13, wherein the corrugated tube has a longitudinal slit facing the two or more sprockets.

15. A drive chain as in claim 14, wherein the width of the longitudinal slit is less than the width of the drive chain.

16. A drive chain as in claim 11,
wherein the drive chain is a bicycle drive chain, and
wherein the corrugated tube
a) is formed of a hard resin,
b) includes ridge portions and trough portions alternating in the longitudinal direction of the corrugated tube, and
c) comprises a slit provided in the longitudinal direction along the length of the corrugated tube.
